(19) United States
(12) Patent Application Publication
(10) Pub. No.: US 2008/0189741 A1
(43) Pub. Date: Aug. 7, 2008

(54) METHOD AND APPARATUS FOR STORING ELECTRONIC PROGRAM GUIDE (EPG), AND METHOD AND APPARATUS FOR PROVIDING EPG

(75) Inventor: Yun-ju CHOE, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/873,632

(22) Filed: Oct. 17, 2007

(30) Foreign Application Priority Data
Feb. 5, 2007 (KR) 2007-11825

(51) Int. Cl. G06F 3/00

(52) U.S. Cl. 725/39

(57) ABSTRACT

An Electronic Program Guide (EPG) storing method, the EPG storing method including: receiving an EPG including program information for at least one program; and storing the program information included in the EPG in a database assigned to an index number corresponding to the at least one program with reference to an index map in which index numbers are respectively assigned to programs. Accordingly, users can easily obtain the previous information for the user's desired program from a device that the user watches without using other devices, such as the Internet.

### CROSS-REFERENCE TO RELATED APPLICATION

This application claims the benefit of Korean Application No. 2007-11825, filed on Feb. 5, 2007 in the Korean Intellectual Property Office, the disclosure of which is incorporated herein by reference.

### BACKGROUND OF THE INVENTION

1. Field of the Invention

Aspects of the present invention relate to a digital television (DTV) system, and more particularly, to a method and apparatus for storing an Electronic Program Guide (EPG), and a method and apparatus for providing an EPG.

2. Description of the Related Art

Electronic devices such as televisions (TVs) and personal computers (PCs) require control systems that include a user interface system. Conventionally, a user interface provides information to a user, and simplifies the use of a device for which the user interface is provided. For example, an Electronic Program Guide (EPG) is a user interface that is used in a television system.

The EPG displays a list (similar to a television program list that can be used in local newspapers or other printed media) and includes information required for comparing programs with each other and decoding the programs. Conventionally, the EPG provides, to users, information regarding each program in time frames that are covered by the EPG having a range from the following one hour to several days. The information included in the EPG includes program characteristics (such as channel numbers, program titles, start times, end times, elapsed times, remaining times, themes, and summaries of program contents). The EPG can be displayed in the form of a two-dimensional table that has time information on one axis and program source information (such as channel information) on the other axis.

As digital broadcast systems have become more popular, users are able to receive hundreds of channels. Furthermore, an EPG that includes information for a broadcast can be transmitted between broadcast signals in order to provide a large amount of program information to users. Accordingly, the users can selectively watch their desired programs through the EPG.

A digital TV receives EPG information for each broadcasting station every predetermined time interval and stores the EPG information in a predetermined memory. The EPG information is used to allow a user to tune a specific channel. Furthermore, the EPG information is displayed as an EPG menu on a screen using a predetermined graphic processing block when the user searches for a plurality of program information for each hour or for each channel. As a result, the user can search for his or her desired program for each date, for each hour, for each broadcasting station, etc., through the EPG menu.

FIG. 1 illustrates a conventional EPG screen. Referring to FIG. 1, the columns of the conventional EPG screen represents broadcast times, and the rows of the conventional EPG screen represents channels. That is, the conventional EPG system shows program information according to channels and broadcast times. For example, there is News 11 from 10:30 to 11:00 on channel 9-2, and there is “Jumong” 12, which is an HD special drama of MBC, from 10:30 to 11:30 on channel 11-1,

Since the News 11 is not a series, there is little need for checking the previous episode's plot. However, since the drama “Jumong” 12 is a series, there is a greater need for checking the previous episode's plot. If a user wants to know the plot of the current episode of the drama “Jumong”, he or she can search for the corresponding EPG to check this information (“Mopalmo and Moosong which are abducted by Songyang and put in prison. Songyang decides to send Mopalmo to the prince Daeso and tries to send Mopalmo to Buyeo”).

However, if the user wants to know the plot of the previous episode of the drama “Jumong” 12, he or she must search for the previous EPG to check this information (“Jumong infiltrates into the Buyeokung and looks for Youwha's sleeping phace. Youwha is very surprised at the abrupt appearance of Jumong which has become known as the dead”).

As such, conventionally, when a user wants to obtain previous information for a program (such as the drama “Jumong” 12), there is an inconvenience in that he or she must search for the previous EPG to find the corresponding program.

### SUMMARY OF THE INVENTION

Aspects of the present invention provide an Electronic Program Guide (EPG) storing method that is capable of easily searching for previous information of a program, and an EPG providing method that is capable of easily searching for the previous information of a program. Aspects of the present invention also provide an EPG storing apparatus that is capable of easily searching for the previous information of a program, and an EPG providing apparatus that is capable of easily searching for the previous information of a program.

According to an aspect of the present invention, there is provided a method of storing an Electronic Program Guide (EPG), the method including: receiving an EPG including program information for at least one program; and storing the program information included in the EPG in a database assigned to an index number corresponding to the at least one program, with reference to an index map in which index numbers are respectively assigned to programs.

The storing of the program information included in the EPG may include: determining whether the index number corresponding to the at least one program exists in the index map; and if the index number corresponding to the at least one program does not exist in the index map, generating a new index number corresponding to the at least one program and storing the new index number in the index map.

The index map may be generated by respectively assigning index numbers to programs according to titles of the programs, for each channel.

The program information may include a channel, a title, and summary information of the at least one program, and the storing of the program information included in the EPG may include: determining whether an index map corresponding to the channel of the at least one program exists; and if the index map corresponding to the channel of the at least one program does not exist, generating a new index map corresponding to the channel of the at least one program.

The program information may include a broadcast date and time, a title, and summary information of the at least program, and the storing of the program information included in the EPG may include storing the broadcast date and time, the title, and the summary information of the at least one program in the database assigned to the index number.

The index map may be updated every deletion period of the database.

The deletion period of the database may be set by a user.

The index map may be automatically deleted when a storage capacity of the database is insufficient.

According to another aspect of the present invention, there is provided a computer-readable recording medium encoded with the method and implemented by a computer.

According to another aspect of the present invention, there is provided a method of providing an Electronic Program Guide (EPG), the method including: receiving a program selection signal indicating a predetermined program; searching for a database assigned to an index number corresponding to the predetermined program with reference to an index map in which index numbers are respectively assigned to programs; and displaying program information of the predetermined program stored in the database, wherein the database is generated by assigning program information for at least one program included in an EPG to an index number corresponding to the at least one program.

The program information may include a channel, a title, summary information, and preview images of the predetermined program.

According to another aspect of the present invention, there is provided a computer-readable recording medium encoded with the method and implemented by a computer.

According to another aspect of the present invention, there is provided a method of storing an Electronic Program Guide (EPG), the method including: receiving an EPG including program information for at least one program; determining whether the EPG belongs to a predetermined genre; and if the EPG belongs to the predetermined genre, storing the program information included in the EPG in a genre-based storage unit.

According to another aspect of the present invention, there is provided a computer-readable recording medium encoded with the method and implemented by a computer.

According to another aspect of the present invention, there is provided an Electronic Program Guide (EPG) storage apparatus including: an EPG receiving unit receiving an EPG including program information for at least one program; an EPG processing unit determining whether an index number corresponding to the at least one program is included in an index map in which index numbers are respectively assigned to programs; and an EPG storage unit storing the program information included in the EPG in a database assigned to the index number corresponding to the at least one program.

If the index number corresponding to the at least one program is not included in the index map, the EPG processing unit may generate a new index number corresponding to the at least one program and store the new index number in the index map.

The index map may be generated by respectively assigning index numbers to programs according to titles of the programs, for each channel.

The program information may include a channel, a title, and summary information of the at least one program, and the EPG processing unit may determine whether an index map corresponding to the channel of the at least one program exists, and generate a new index map corresponding to the channel of the at least one program if the index map corresponding to the channel of the at least one program does not exist.

The program information may include a broadcast date and time, a title, summary information, and preview images of the at least one program, and the EPG storage unit may store the broadcast date and time, the title, and the summary information of the at least one program in a database assigned to the index number.

The index map may be updated every deletion period of the EPG storage unit.

The deletion period of the EPG storage unit may be set by a user.

The index map may be automatically deleted when a storage capacity of the EPG storage unit becomes insufficient.

The EPG storage unit may include a genre-based storage unit storing the at least one program if the at least one program included in the EPG belongs to a predetermined genre.

According to another aspect of the present invention, there is provided an Electronic Program Guide (EPG) providing apparatus including: a receiving unit receiving a program selection signal indicating a predetermined program; a search unit searching for a database assigned to an index number corresponding to the predetermined program with reference to an index map in which index numbers are respectively assigned to programs; a display unit displaying program information of the predetermined program stored in the database, wherein the database is generated by assigning program information for at least one program included in an EPG to an index number corresponding to the at least one program.

The display unit may display summary information and preview images for a previously broadcasted episode of the predetermined program.

According to another aspect of the present invention, there is provided an Electronic Program Guide (EPG) storage apparatus including: an EPG receiving unit to receive an EPG including preview images for at least one program; and an EPG storage unit to store the preview images included in the EPG for a current episode and previous episodes of the at least one program in a database assigned to an index number corresponding to the at least one program.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a conventional Electronic Program Guide (EPG) screen;

FIG. 2 illustrates an index map according to EPG channels, according to an embodiment of the present invention;

FIG. 3 illustrates an EPG database according to an embodiment of the present invention;

FIG. 4 is a block diagram of an EPG storage apparatus according to an embodiment of the present invention;

FIG. 5 illustrates an EPG screen according to an embodiment of the present invention;

FIG. 6 is a flowchart of an EPG storing method according to an embodiment of the present invention;

FIG. 7 is a block diagram of an EPG providing apparatus according to an embodiment of the present invention; and

FIG. 8 is a flowchart of an EPG providing method according to an embodiment of the present invention.

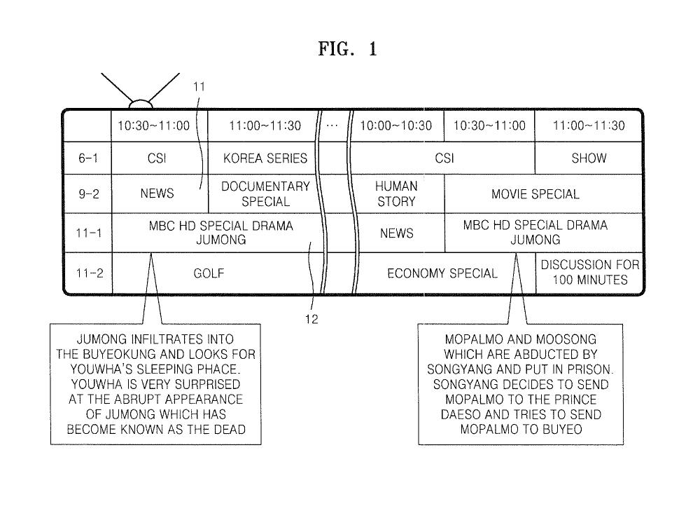

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

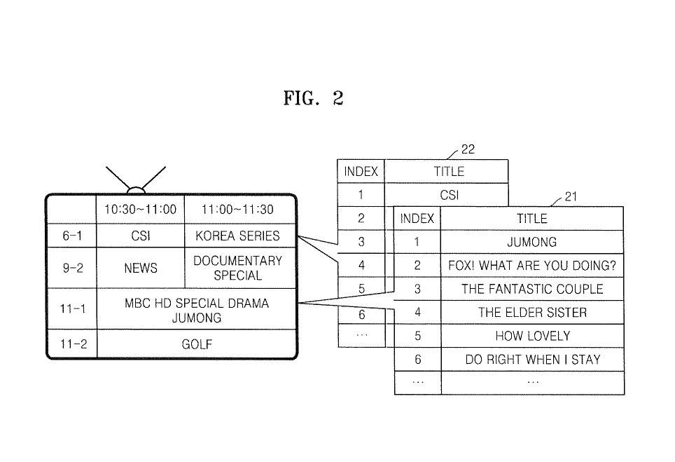

FIG. 2 illustrates an index map according to EPG channels, according to an embodiment of the present invention. Referring to FIG. 2, a first index map 21 is generated by assigning index numbers to programs broadcasting on channel 11-1 according to the programs' titles. A second index map 22 is generated by assigning index numbers to programs broadcasting on channel 6-1 according to the programs' titles. That is, if an EPG for N channels is received, N index maps are generated. Although only two index maps (i.e., the first and the second index maps 21 and 22) are illustrated in FIG. 2, aspects of the present invention are not limited thereto, and the EPG can more than two index maps corresponding to more than two channels.

Each index map includes a plurality of index numbers assigned to a plurality of programs broadcasting on the corresponding channel. In the case of the first index map 21, index numbers are respectively assigned to programs broadcasting on channel 11-1 according to the programs' titles. In detail, in the first index map 21, “Jumong” corresponds to index number 1, “Fox! What are you Doing?” corresponds to index number 2, “The Fantastic Couple” corresponds to index number 3, “The Elder Sister” corresponds to index number 4, “How Lovely” corresponds to index number 5, and “Do Right When I Stay” corresponds to index number 6.

In the case of the second index map 22, index numbers are respectively assigned to programs broadcasting on channel 6-1 according to the programs' titles. In detail, in the second index map 22, “CSI” corresponds to index number 1.

In the first and second index maps 21 and 22 illustrated in FIG. 2, the index numbers are respectively assigned to the programs, according to the programs' titles. However, aspects of the present invention are not limited thereto, and for example, the index numbers can be respectively assigned to the programs according to the programs' codes.

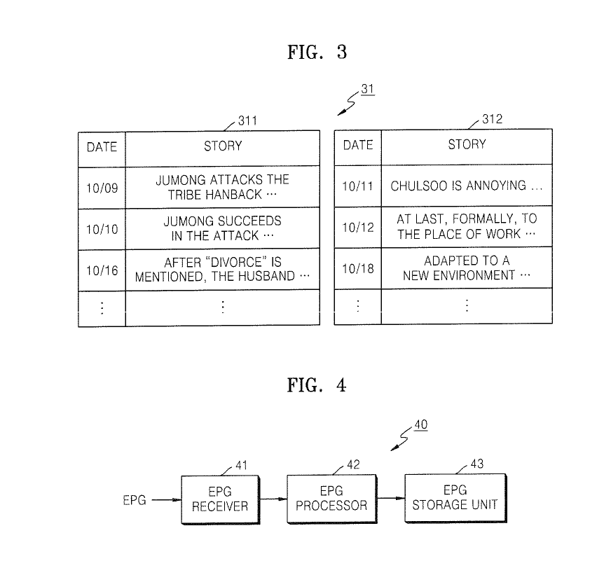

FIG. 3 illustrates an EPG database 31 according to an embodiment of the present invention. Referring to FIG. 3, the EPG database 31 stores EPG information for the channel 11-1 (see FIG. 2), and includes a first EPG database 311 and a second EPG database 312. Date information and contents corresponding to each date are stored in the first and the second databases 311 and 312. While only the first and the second EPG databases 311 and 312 are illustrated in FIG. 3, it is understood that aspects of the present invention are not limited thereto, and, for example, the EPG database 31 can include more than two EPG databases according to a plurality of index numbers.

Referring to FIGS. 2 and 3, the EPG database 31 corresponds to the first index map 21 in which index numbers are assigned to programs broadcasting on channel 11-1 according to the programs' tiles. In the first EPG database 311, information for “Jumong” corresponding to the index number 1 of the first index map 21 is stored according to dates. In the second EPG database 312, information for “Fox! What are you Doing?” corresponding to the index number 2 of the first index map 21 is also stored according to dates. For example, plot information for the drama “Jumong” broadcasted on October 9^{th}, October 10^{th}, and October 16^{th} are stored according to the dates in the first EPG database 311. Moreover, plot information for “Fox! What are you doing?” broadcasted on October 11^{th}, October 12^{th}, and October 18^{th} are stored according to the dates in the second database 312.

The first and the second index maps 21 and 22 (illustrated in FIG. 2) can be updated every deletion period of the EPG database 31. The deletion period of the EPG database 31 can be set by a user. However, aspects of the present invention are not limited thereto, and the program information stored in the EPG database 31 may updated in other ways. For example, the program information may only be deleted manually by a user, or the first and second index maps 21 and 22 may be automatically deleted when the storage capacity of the EPG database 31 becomes insufficient.

FIG. 4 is a block diagram of an EPG storage apparatus 40 according to an embodiment of the present invention. Referring to FIG. 4, the EPG storage apparatus 40 includes an EPG receiver 41, an EPG processor 42, and an EPG storage unit 43. The EPG storage apparatus 40 according to aspects of the present invention can be applied to Digital Televisions (DTVs), Internet Protocol Televisions (IPTVs), etc.

The EPG receiver 41 receives an EPG from a broadcast station. The EPG includes a channel of at least one program, the program's title, program-related information, etc. The program-related information can include summary information, a plot, preview images, etc.

The EPG processor 42 determines whether an index number corresponding to the program exists in an index map in which index numbers are assigned to programs. That is, the EPG processor 42 determines whether the program included in the EPG is included in at least one index map in which index numbers are assigned to programs according to the programs' titles (or other identifier of the program), and whether the program's title corresponds to at least one index number included in the index map. Alternatively, the EPG processor 42 determines whether the channel of the program included in the EPG is included in at least one index map in which index numbers are assigned to channels according to programs' titles (or other identifier of the program), and whether the program's title corresponds to at least one index number included in the index map.

If the program included in the EPG is included in at least one index map, and the program's title corresponds to at least one index number included in the index map, the EPG storage unit 43 stores the program-related information included in the EPG in a database assigned to the index number corresponding to the program.

Hereinafter, the operation of the EPG storage apparatus 40 will be described in detail with reference to FIGS. 2, 3, and 4. The EPG processor 42 assigns index numbers for each channel to the EPG received from the EPG receiver 41, according to the programs' titles (or other identifier of the program). The EPG processor 42 can include an index map generator (not shown) and an index generator (not shown).

The index map generator can generate a new index map when the channel of the program included in the EPG is not included in the first and the second index maps 21 and 22 (i.e., the channel of the program does not have an existing corresponding index map). The index generator can assign a new index number to the first or the second index map 21 or 22 when the program's title (or other identifier of the program) included in the EPG does not correspond to at least one index number of the first and the second index maps 21 and 22 (i.e., the program does not have an assigned index number).

For example, when information for programs entitled “Jumong” and “Fox! What are you Doing?” broadcasting on channel 11-1 exist in an EPG on October 9^{th}, the two programs entitled “Jumong” and “Fox! What are you Doing?” are included in the first index map 21 since they are broadcasted on channel 11-1. Also, index number 1 of the first index map 21 is assigned to the program entitled “Jumong” according to the program's title. Index number 2 of the first index map 21 is assigned to the program entitled “Fox! What are you Doing?” according to the program's title.

Also, when information for two programs entitled “Jumong” and “Discussion for 100 Minutes” broadcasting on channel 11-1 exist in an EPG on October 10^{th}, the EPG processor 42 first checks the first index map 21 corresponding to channel 11-1 to determine whether index numbers are assigned to the two programs.

As a result of the determination, since the program entitled “Jumong” corresponds to the index number 1 of the first index map 21, no new index number is assigned to the program entitled “Jumong.” The information for the program “Jumong” broadcasting on October 10^{th} is stored in an EPG database which is assigned to the index number 1 of the first index map 21 (i.e., in the first EPG database 311).

However, since the program entitled “Discussion for 100 Minutes” does not correspond to an index number of the first index map 21, a new index number is assigned to the program entitled “Discussion for 100 Minutes.” The information for the program “Discussion for 100 Minutes” broadcasting on October 10^{th} is stored in an EPG database that is assigned to a corresponding index number, as indicated in the first index map 21.

It is understood that aspects of the present invention are not limited thereto, and the EPG processor 42 can assign index numbers to programs according to, for example, the programs' codes.

As such, since program information (such as program summary information or preview images) is stored in an EPG database, a user can search for a program for each channel or for each date, or can successively check all information together. Also, the user can view information on previous programs in the format of text or images by using program summary information or preview images. However, aspects of the present invention are not limited thereto, and the EPG database 31 can, for example, further include a genre-based storage unit.

That is, if the received EPG includes information on a program genre, the user can selectively store only program information corresponding to a desired genre. For example, a case where the user requires information of a previous program occurs frequently when the user watches a series program. Because most series programs are dramas, the user can set the EPG storage apparatus 40 so that only program information corresponding to a drama genre is stored in the EPG database 31.

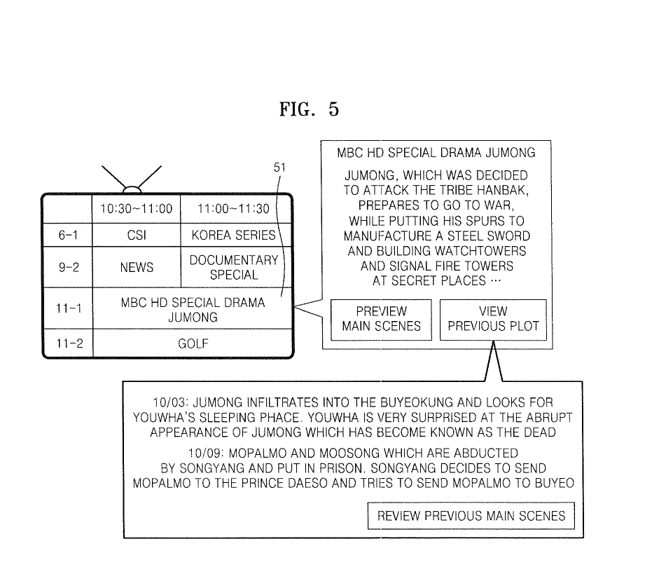

FIG. 5 illustrates an EPG screen according to an embodiment of the present invention. Referring to FIG. 5, time information is displayed at the horizontal axis of the EPG screen, and channel information is displayed at the vertical axis of the EPG screen so that a user can check program information according to times and channels. For example, if the user selects an HD special drama “Jumong” 51 of MBC broadcasting on channel 11-1 from 10:30 to 11:30, the user can check program information (such as the previous plot or main scenes) of the drama “Jumong” 51.

The program information is stored in an EPG database, according to index numbers, for each channel, as illustrated in FIG. 3. The program information may include the main scenes, plot, etc. of the corresponding program. Accordingly, by using the main scenes, plots, etc., of programs stored in an EPG database, the user can check information on previous episodes of the user's desired program.

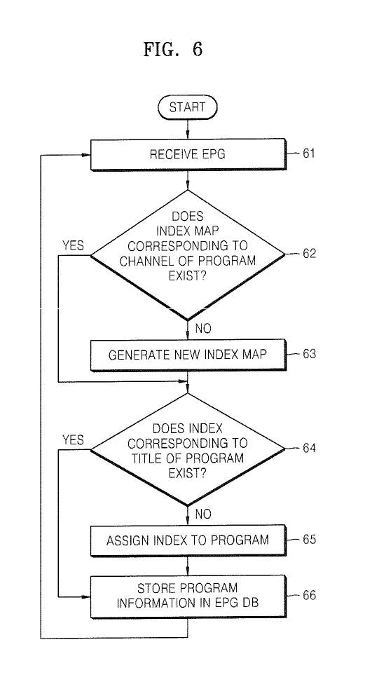

FIG. 6 is a flowchart of an EPG storing method according to an embodiment of the present invention. Referring to FIG. 6, first, an EPG including program information for at least one program is received from a broadcast station in operation 61. The program information may include the program's channel, the program's title, the program's main scenes, the program's plot, etc.

Then, it is determined whether an index map corresponding to the program's channel exists in operation 62. As described with reference to FIG. 2 above, an index map is generated for each channel, and includes a plurality of index numbers that are classified according to programs' titles (or other program identifiers).

If no index map corresponding to the program's channel exists (operation 62), a new index map corresponding to the program's channel is generated in operation 63.

If an index map corresponding to the program's channel exists (operation 62), it is determined whether the program's title (or other program identifier) corresponds to one of a plurality of index numbers included in the index map in operation 64.

If the program's title does not correspond to one of the index numbers included in the index map (operation 64), a new index number is assigned to the program in operation 65.

Then, the information for the program is stored in an EPG database assigned to the corresponding index number in operation 66.

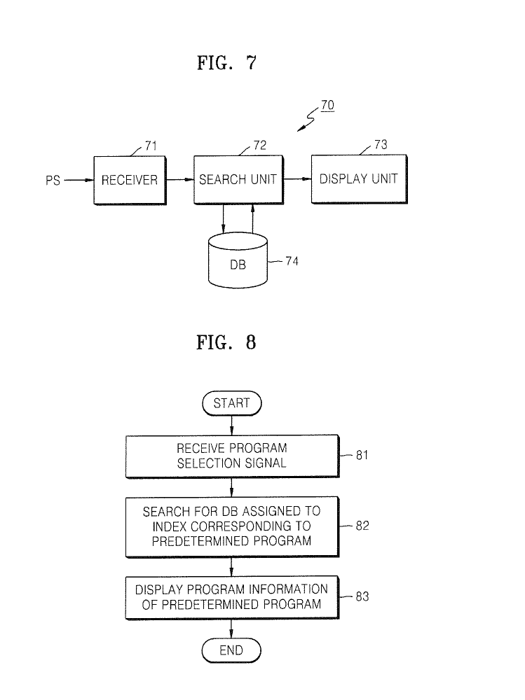

FIG. 7 is a block diagram of an EPG providing apparatus 70 according to an embodiment of the present invention. Referring to FIG. 7, the EPG providing apparatus includes a receiver 71, a search unit 72, and a display unit 73.

The receiver 71 receives a program selection signal (PS) indicating a program selected by a user. For example, the user can input the PS to the EPG providing apparatus 70 through a remote controller.

The search unit 72 searches for a database 74 assigned to an index number corresponding to the program, with reference to an index map in which index numbers are assigned to programs. The index map can be generated by assigning index numbers to programs according to programs' titles (or other program identifiers) for each channel. The database 74 can be generated by assigning program information for at least one program included in an EPG to an index number corresponding to the program.

The display unit 73 displays the program information of the program stored in the database. The program information may include the program's channel, the program's title, the program's summary information, the program's preview images, etc. For example, the display unit 73 may be a DTV or IPTV.

Through the EPG providing apparatus 70, the user can select a drama “Jumong” broadcasting on channel 11-1 from 10:30 to 11:30 and check program information, such as the previous episode's plot or main scenes of the drama “Jumong.”

FIG. 8 is a flowchart of an EPG providing method according to an embodiment of the present invention. Referring to FIG. 8, first, a program selection signal indicating a predetermined program is received in operation 81.

Then, a database assigned to an index number corresponding to the predetermined program is searched for in operation 82. The database is searched for with reference to an index map in which index numbers are assigned to programs. The index map is generated by assigning index numbers to programs according to the programs' titles (or other program identifiers) for each channel. The database can be generated by assigning program information for at least one program included in an EPG to an index number corresponding to the program.

Then, the program information of the predetermined program stored in the database is displayed in operation 83. The program information may include the program's channel, the program's title, the program's summary information, and the program's preview images.

Aspects of the present invention can also be embodied as computer-readable codes on a computer-readable recording medium. The computer-readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and a computer data signal embodied in a carrier wave comprising a compression source code segment comprising the code and an encryption source code segment comprising the code (such as data transmission through the Internet). The computer-readable recording medium can also be distributed over network-coupled computer systems so that the computer-readable code is stored and executed in a distributed fashion.

As described above, in an EPG storing method and apparatus and an EPG providing method and apparatus according to aspects of the present invention, a user can easily obtain previous episode information for the user's desired program from a device that the user watches, without using other devices such as the Internet.

Furthermore, when the user wants to once more watch the previous episode although the watching of the previous episode is charged, by storing a plot and preview images transmitted from a broadcast station and using them as a summary of the previous program, the user's fee load can be reduced.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of storing an Electronic Program Guide (EPG), the method comprising:
receiving an EPG including program information for at least one program; and
storing the program information included in the EPG in a database assigned to an index number corresponding to the at least one program, with reference to an index map in which index numbers are respectively assigned to programs.

2. The method as claimed in claim 1, wherein the storing of the program information included in the EPG further comprises:
determining whether an index number corresponding to the at least one program exists in the index map; and
generating a new index number corresponding to the at least one program and storing the new index number in the index map if the index number corresponding to the at least one program does not exist in the index map.

3. The method as claimed in claim 1, wherein the index map is generated by assigning a first index number to a first program and a second index number to a second program.

4. The method as claimed in claim 3, wherein the index map corresponds to only one channel.

5. The method as claimed in claim 3, wherein the first index number is assigned to the first program according to a title or code of the first program, and the second index number is assigned to the second program according to a title or code of the second program.

6. The method as claimed in claim 1, wherein the program information comprises a channel, a title, and summary information of the at least one program.

7. The method as claimed in claim 1, wherein the storing of the program information with reference to an index map comprises:
determining whether an index map corresponding to a channel of the at least one program exists; and
generating a new index map corresponding to the channel of the at least one program if the index map corresponding to the channel of the at least one program does not exist.

8. The method as claimed in claim 1, wherein:
the program information comprises a broadcast date and time, a title, and summary information of the at least program; and
the storing of the program information comprises storing the broadcast date and time, the title, and the summary information of the at least one program in the database assigned to the index number.

9. The method as claimed in claim 1, wherein the index map is updated every deletion period of the database or at least a portion of the index map is automatically deleted when a storage capacity of a unit storing the database becomes insufficient.

10. The method as claimed in claim 9, wherein the deletion period of the database is set by a user.

11. The method as claimed in claim 1, wherein the storing of the program information comprises:
determining whether the at least one program belongs to a predetermined genre;
storing the program information in the database only if the at least one program belongs to the predetermined genre.

12. A computer-readable recording medium having recorded thereon a computer program for executing a method of storing an Electronic Program Guide (EPG), the method comprising:
receiving an EPG including program information for at least one program; and
storing the program information included in the EPG in a database assigned to an index number corresponding to the at least one program, with reference to an index map in which index numbers are respectively assigned to programs.

13. A method of providing an Electronic Program Guide (EPG), the method comprising:
receiving a program selection signal to select a program;
searching for a database assigned to an index number corresponding to the program, with reference to an index map in which index numbers are respectively assigned to programs; and
displaying program information of the program stored in the database,
wherein the database is generated by assigning the program information for the program included in an EPG to the index number corresponding to the program.

14. The method as claimed in claim 13, wherein the index map is generated by respectively assigning the index numbers to the programs according to titles or codes of the programs.

15. The method as claimed in claim 13, wherein the index map corresponds to only one channel.

16. The method as claimed in claim 13, wherein the program information comprises a summary information of the program.

17. The method as claimed in claim 13, wherein the program information comprises preview images of the program.

18. The method as claimed in claim 13, wherein the displaying of the program information of the predetermined program comprises displaying summary information and preview images for a previously broadcasted episode of the program.

19. A computer-readable recording medium having recorded thereon a computer program for executing a method of providing an Electronic Program Guide (EPG), the method comprising:
receiving a program selection signal to select a program;
searching for a database assigned to an index number corresponding to the program, with reference to an index map in which index numbers are respectively assigned to programs; and
displaying program information of the program stored in the database,
wherein the database is generated by assigning the program information for the program included in an EPG to the index number corresponding to the program.

20. A method of storing an Electronic Program Guide (EPG), the method comprising:
receiving an EPG including program information for at least one program;
determining whether the at least one program belongs to a predetermined genre; and
storing the program information included in the EPG in a storage unit if the at least one program belongs to the predetermined genre.

21. The method as claimed in claim 20, wherein a deletion period of the storage unit, during which the program information is updated, is set by a user.

22. The method as claimed in claim 20, wherein the program information comprises summary information of the at least one program.

23. The method as claimed in claim 20, wherein the program information comprises preview images of the at least one program.

24. The method as claimed in claim 20, wherein a user sets the predetermined genre.
